(19) United States
(12) Patent Application Publication
(10) Pub. No.: US 2015/0135925 A1
(43) Pub. Date: May 21, 2015

(54) ROTARY ANVIL

(71) Applicant: Micro-Surface Finishing Products, Inc., Wilton, IA (US)

(72) Inventor: Allan B. ABRAHAMS, Muscatine, IA (US)

(21) Appl. No.: 14/543,978

(22) Filed: Nov. 18, 2014

Related U.S. Application Data
(60) Provisional application No. 61/906,592, filed on Nov. 20, 2013.

(51) Int. Cl. B26D 7/20

(52) U.S. Cl. CPC B26D 7/204
USPC 83/659

(57) ABSTRACT

A rotary die and anvil system includes a rotary die having at least one blade for cutting a material and a bearer surface positioned on opposite sides of the blade. A rotary anvil is provided with a central shaft and a cylindrical body formed around the central shaft. The rotary anvil comprises of an aluminum filled epoxy resin. The rotary die drives the cylindrical body in a counter-rotational direction by frictional force exerted by the bearer surface positioned on opposite sides of the blade. The blade of the rotary die penetrates into the cylindrical body to sharpen the blade of the rotary die without deforming the blade.

This application claims priority to Provisional Application No. 61/906,592 filed on Nov. 20, 2013, the contents of which are hereby incorporated by reference herein.

This invention relates to a rotary anvil for cutting, creasing, perforating, or embossing sheet materials, and more particularly to a rotary anvil that sharpens the blades of a rotary die while it is working.

### BACKGROUND

A rotary die cutting machine cuts sheet material with a cooperating rotary die and rotary anvil. The anvil provides a supporting surface against which the blades of the rotary die work. As sheet material is fed into the rotary die cutting machine, the counter-rotating rollers pull the sheet material through and the blades of the rotary die perform their cutting, creasing, perforating, or embossing action. In this arrangement, the blades are continually pressed downward into the rotary anvil in order to penetrate the sheet material. Because these anvils are typically formed of machined steel with a standard durometer of 70 shore D, the blades quickly wear, bend, or deform. What is needed is a rotary anvil that will extend the useful life of the rotary die.

### SUMMARY

A rotary die and anvil system is disclosed. The system includes a rotary die having at least one blade for cutting a material and a bearer surface positioned on opposite sides of the blade. A rotary anvil is provided with a central shaft and a cylindrical body formed around the central shaft. The rotary anvil comprises of an aluminum filled epoxy resin. The rotary die drives the cylindrical body in a counter-rotational direction by frictional force exerted by the bearer surface positioned on opposite sides of the blade. The blade of the rotary die penetrates into the cylindrical body to sharpen the blade of the rotary die without deforming the blade.

A central hub extends through the rotary die and an external force applies substantially constant and consistent pressure on opposite ends of the rotary die to urge the bearer surface positioned on opposite sides of the blade into the rotary anvil in an amount sufficient to cause counter-rotation of the rotary anvil with minimal deformation of the blade.

In an embodiment, the cylindrical body of the rotary anvil is casted to the central shaft. As the cylindrical body of the rotary anvil wears from being driven by the frictional force of the bearer surface positioned on opposite sides of the blade of the rotary die, a pair of impression are formed on the cylindrical body that correspond in location with the bearer surface positioned on opposite sides of the blade to maintain the blades of the rotary die in substantially constant contact with the cylindrical body.

### BRIEF DESCRIPTION OF THE DRAWINGS

FIG. 1 is a rotary die.

FIG. 2 is a rotary anvil according to an embodiment of this disclosure.

FIG. 3 is a front view of the rotary anvil of FIG. 2.

FIG. 4 is the rotary anvil of FIG. 2 after having been used.

FIG. 5 is a perspective view of the rotary die and rotary anvil operating according to an embodiment of this disclosure.

FIG. 6 is a side view of the rotary die and rotary anvil of FIG. 5.

### DETAILED DESCRIPTION

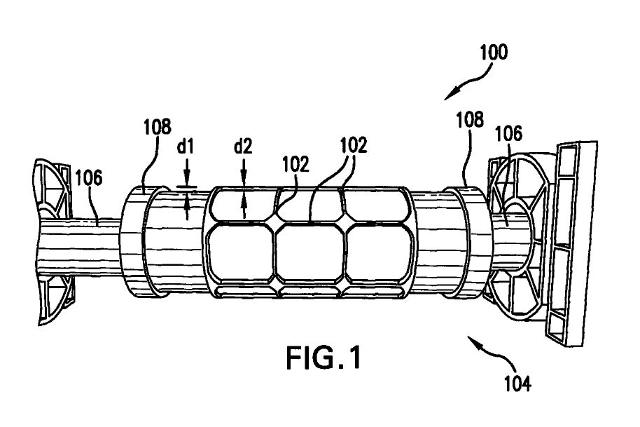

FIG. 1 shows a rotary die 100. Rotary die 100 includes one or more blades 102 formed on a central body 104, which is supported on a central hub 106. Blades 102 can be formed in any pattern corresponding to a desired cutting shape. In the illustrated embodiment, blades 102 are formed in a generally square shape to cut squares in a sheet material 400 (see FIGS. 7 and 8). Each end of central body 104 includes a bearer surface 108 so there are two bearer surfaces 108. Bearer surface 108 is the portion of rotary die 100 that is pressed against a rotary anvil 200, as discussed below.

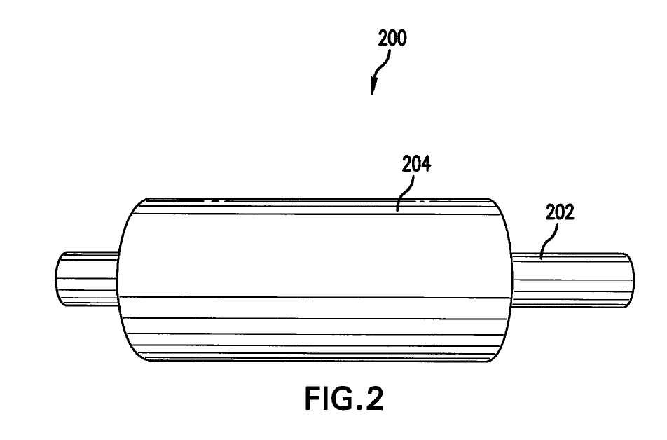

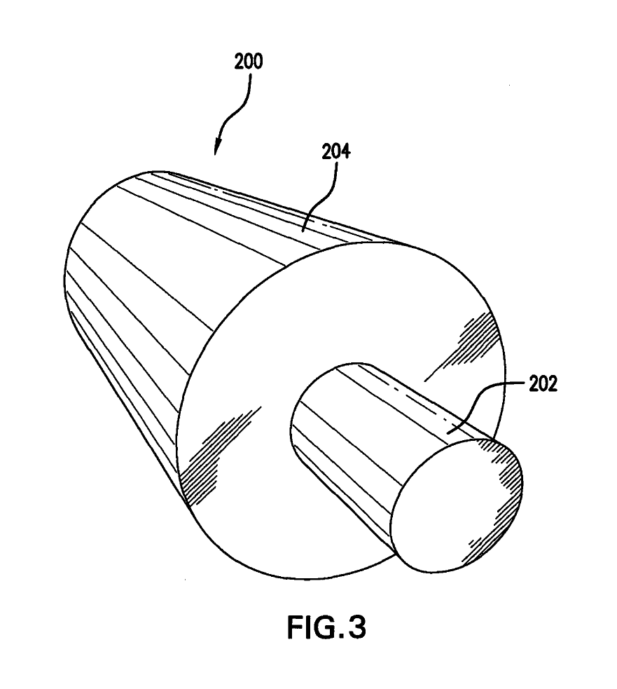

FIGS. 2 and 3 show rotary anvil 200. Rotary anvil 200 has a central body 204 made of aluminum filled epoxy resin that is molded around a central hub 202. When rotary anvil 200 is removed from a mold, central body 204 is substantially smooth and of a consistent diameter. Central body 204 can be any type of polymer or plastic or a machineable plastic, such as Delron. However, the preferred method of manufacture of central body 204 is molding, and therefore, central body 204 is preferably made from an epoxy or urethane. Central body preferably has a hardness of 50 Shore D to 93 Shore D (or any range therebetween), and the preferred hardness is 90 Shore D, where D is for diameter.

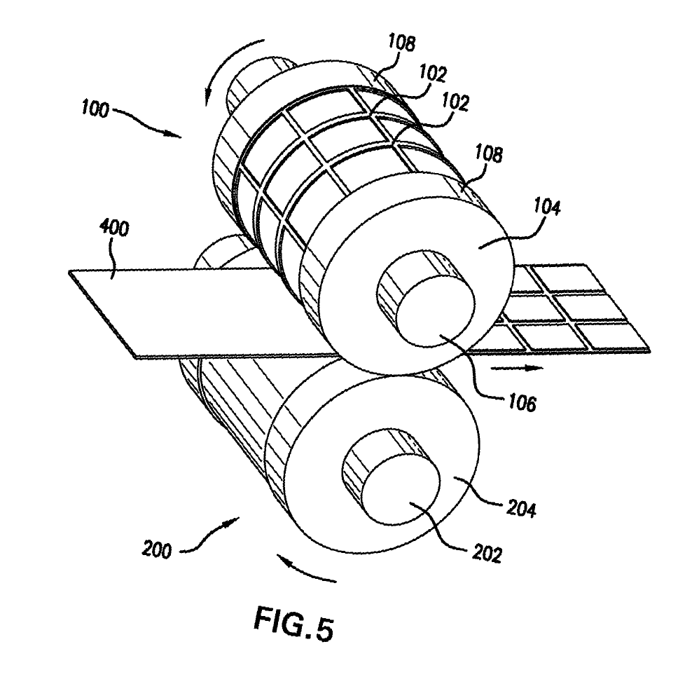

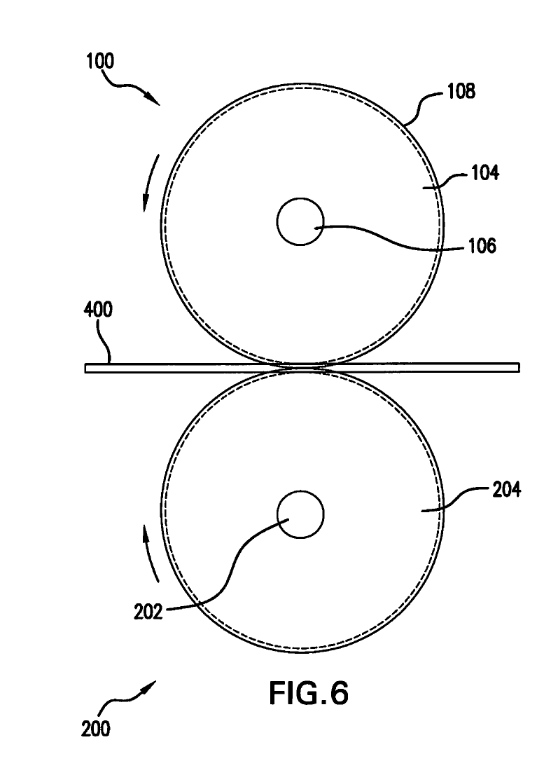

FIGS. 5 and 6 show rotary die 100 cooperating with rotary anvil 200 to work a sheet material 400. Rotary die 100 is rotationally driven by an external motor to rotate around an axis that extends through central hub 106. An external force is also provided from above to push rotary die 100 downward against rotary anvil 200. The downward pressure of rotary die 100 into rotary anvil 200 creates a frictional contact between the respective central bodies 104 and 204 such that rotation of rotary die 100 in a counter-clockwise direction causes rotation of rotary anvil in a clockwise direction. In this regard, rotary anvil 200 is freewheeling and driven only by the frictional force of rotary die 100.

Because rotary anvil 200 is freewheeling and driven only by frictional force, considerable downward pressure onto rotary anvil 200 is required to drive its rotation. Bearers 108 on each end of rotary die 100 are the contacting surfaces where the pressure is applied, as opposed to blades 102 in prior art dies. Rotary anvil 200 is designed to wear at the location of impact of bearers 108, so that blades 102 are kept in constant contact with rotary anvil 200. This prevents blades 102 from deforming or folding under the downward pressure of rotary die 100 into rotary anvil 200.

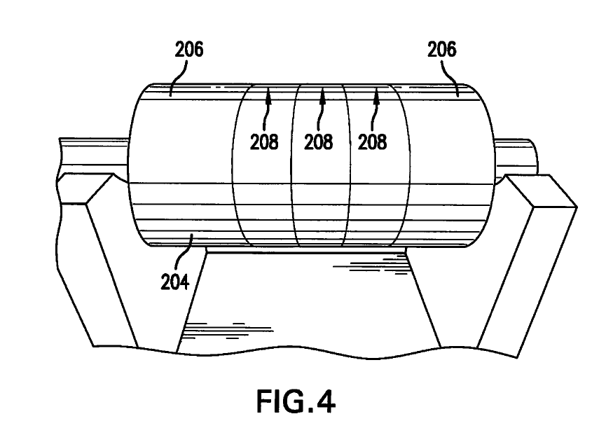

FIG. 4 shows a used rotary anvil 200 with bearer impressions 206 at each end of central body 204. These impressions 206 correspond to the depth bearers 108 extend into central body 204 of rotary anvil 200. Also shown are three rows of blade impression 208, which correspond to the three rows of cutting blades 102. Cutting blades 102 penetrate slightly into the surface of central body 204 of rotary anvil 200, but not so hard as to be deformed. The aluminum in the composition of central body 204 actually sharpens blades 102 while the rotary die cutting machine 100 is in operation. As a result of this function, the production life of rotary die 100 is increased several hundred percent, and is not subject to the damage caused by contact with a hard steel anvil 200.

Eventually, as rotary anvil 200 is used, it will reach a point that it has to be replaced, depending on the amount of damage caused from the pressure of bearers 108 into central body 204. Unlike hard steel rollers that have to be re-machined and eventually replaced after considerable wear, rotary anvil 200 is removed, placed into a mold, and a new surface is poured and casted. The cost of rotary anvil is about 30% of a new steel anvil. Resurfacing of the soft anvil to original condition would be several hundred dollars as opposed to several thousand dollars to replace a hard steel anvil. Furthermore, the process of resurfacing rotary anvil 200 can be repeated as many times as is necessary and rotary anvil 200 rarely has to be replaced. This process saves the user thousands of dollars in tooling replacement for both rotary anvil 200 and rotary die 100.

Since rotary anvil 200 conforms to whatever rotary die 100 that is being used and simultaneously sharpens blades 102, the cut in sheet material 400 that is produced well exceeds the quality of the cut produced using a hard steel roller anvil.

What is claimed is:

1. A rotary anvil driven by a rotary die with blades formed in the rotary die for cutting, creasing, perforating, or embossing a sheet materials, the rotary anvil comprising:
a central shaft;
a cylindrical body formed around the central shaft and comprising of an aluminum filled epoxy resin; and
wherein, the rotary die drives the cylindrical body in a counter-rotational direction by frictional force exerted by the rotary die against the cylindrical body, and wherein the blades of the rotary die penetrate into the cylindrical body to sharpen the blades of the rotary die.

2. The rotary anvil of claim 1, wherein the cylindrical body is casted to the central shaft.

3. The rotary anvil of claim 1, wherein the rotary die has two bearer surfaces on opposite ends of the rotary die, and wherein the bearer surfaces are pressed against the cylindrical body to drive the cylindrical body in the counter-rotational direction by the frictional force.

4. The rotary anvil of claim 3, wherein as the cylindrical body wears from being driven by the frictional force of the two bearer surfaces of the rotary die, a pair of impression are formed on the cylindrical body that correspond in location with the two bearer surfaces to maintain the blades of the rotary die in substantially constant contact with the cylindrical body.

5. The rotary anvil of claim 1, and further comprising a shore durometer of substantially equal to 90 Shore D.

6. A rotary die and anvil system comprising:
a rotary die having at least one blade for cutting a material and a bearer surface positioned on opposite sides of the blade; and
a rotary anvil having a central shaft and a cylindrical body formed around the central shaft and comprising of an aluminum filled epoxy resin, wherein the rotary die drives the cylindrical body in a counter-rotational direction by frictional force exerted by the bearer surface positioned on opposite sides of the blade, and wherein the blade of the rotary die penetrates into the cylindrical body to sharpen the blade of the rotary die without deforming the blade.

7. The rotary die and anvil system of claim 6, and further comprising a central hub extending through the rotary die, wherein an external force applies substantially constant and consistent pressure on opposite ends of the rotary die to urge the bearer surface positioned on opposite sides of the blade into the rotary anvil in an amount sufficient to cause counter-rotation of the rotary anvil with minimal deformation of the blade.

8. The rotary die and anvil system of claim 6, wherein the cylindrical body of the rotary anvil is casted to the central shaft.

9. The rotary anvil of claim 6, wherein as the cylindrical body of the rotary anvil wears from being driven by the frictional force of the bearer surface positioned on opposite sides of the blade of the rotary die, a pair of impression are formed on the cylindrical body that correspond in location with the bearer surface positioned on opposite sides of the blade to maintain the blades of the rotary die in substantially constant contact with the cylindrical body.

10. The rotary anvil of claim 6, and further comprising a shore durometer of substantially equal to 90 Shore D.
